(19) United States
(12) Patent Application Publication
(10) Pub. No.: US 2004/0087721 A1
(43) Pub. Date: May 6, 2004

(54) Noise and vibration damping materials

(76) Inventors: Jeffrey N. Bruhn, Arnold, MO (US); John Chahine, Sylvan Lake, MI (US)

Correspondence Address: James B. Surber, Bryan Cave LLP, One Metropolitan Square, 211 North Broadway, Suite 3600, St. Louis, MO, 63102, US

(21) Appl. No.: 10/288,228

(22) Filed: Nov. 5, 2002

(51) Int. Cl. C08C 19/00; C08L 33/24

(52) U.S. Cl. 525/132; 525/178; 525/191; 525/192; 525/210; 525/218

(57) ABSTRACT

A visco-elastic material useful in forming a noise and vibration damper, which includes an ethylene/methyl acrylate and/or polyacrylic elastomer, one or more modifying agents and one or more thermally-activated crosslinking agents. The material imparts excellent noise and vibration damping properties over a wide range of temperatures, and is particularly useful for damping vibrating substrates at elevated temperatures. In addition, the material can be polymerized or cured in-situ by heat generating substrates and has self-adhesive characteristics. Furthermore, the damping properties, adhesive qualities and structural integrity of the material are relatively unaffected by prolonged exposure to elevated temperatures and/or hot motor oil.

### BACKGROUND OF THE INVENTION

1. Field of the Invention

The present invention relates generally to noise and vibration damping visco-elastic materials. More specifically, the present invention relates to visco-elastic materials that can be used to dampen vibrating substrates over a wide range of temperatures, and in particular at elevated temperatures.

2. Description of Related Art

The use of visco-elastic materials is an efficient method for dissipating the noise and mechanical energy generated from vibrating surfaces. These materials can be used alone in an unconstrained manner, or in connection with a constraining layer to form a constrained-layer noise and vibration damper. A constrained-layer noise and vibration damper generally consists of at least one layer of visco-elastic material and at least one constraining layer of substantially higher stiffness. The visco-elastic materials known in the art generally comprise natural or synthetic rubbers or mixtures thereof. The constraining layer can be light gauge aluminum foil, steel or aluminum plate, or other high-modulus material. Many of the currently available constrained-layer noise and vibration dampers are used by attaching the visco-elastic portion contiguously against the surface of its substrate, which may require the use of an intermediate adhesive layer or mechanical fastener. In general, visco-elastic materials dampen and in some cases eliminate vibrational energy by converting it into heat energy, which also reduces the noise that would otherwise be generated by the vibrating substrate.

Constrained-layer dampers are useful in many different applications. The automotive industry, for example, uses constrained-layer dampers to control the noise generated by vibrating automobile body panels. In addition, constrained-layer dampers are often used in connection with automotive powertrain components, disc brakes, transmissions, compressors, electronics and speakers. When used at the sources of noise and vibration, however, constrained-layer dampers are often exposed to a wide range of temperatures, and in many instances extremely high temperatures. This is the case with automotive powertrain components, for example, which generally operate at temperatures in excess of 200° F. (93° C.) over extended periods of time. In addition, when used in connection with automotive parts, constrained-layer dampers are often exposed to motor oils and other harsh solvents.

There are many types of polymers known to be useful in formulating visco-elastic materials. Some of these polymers are crosslinked to one another before the visco-elastic material is formulated, which is generally the case for butyl and EVA (ethylene-vinyl acetate) based materials. Many of the butyl and EVA based visco-elastic materials, however, do not exhibit favorable damping properties at elevated temperatures (>200° F./93° C.). Other visco-elastic materials known in the art contain polymers that must be crosslinked to one another after formulation in order to achieve optimum damping properties. The process of crosslinking the polymers to one another is commonly referred to as “curing” the material. Depending on the type of polymers used to formulate a visco-elastic material, the curing process can be induced using radiation, heat and/or chemical crosslinkers.

After a visco-elastic material is formulated, it can be cured on a release liner if necessary. After curing, the visco-elastic material can be transferred from the release liner to a constraining layer. Other visco-elastic materials can be formulated and applied directly to a constraining layer and allowed to cure. In high temperature applications, it is more preferable to use visco-elastic materials that can be thermally cured. In such case, the visco-elastic materials can be applied directly to heat generating substrates and will cure in-situ.

Many of the previously known visco-elastic materials require the use of an intermediate adhesive layer and/or other mechanical means to firmly attach the materials to vibrating substrates. The need for adhesives and/or mechanical fasteners is particularly common for applications involving high temperatures (>200° F./93° C.). In high temperature applications, it is therefore preferable to use visco-elastic materials that have inherent adhesive properties. In such case, the visco-elastic materials can be attached to substrates without the need for an intermediate adhesive layer and/or mechanical fastener.

In light of the foregoing, it would be desirable to provide visco-elastic materials that can optionally be used in connection with a constraining layer and provide: (i) good noise and vibration damping properties over a wide range of temperatures, and preferably at the elevated temperatures common to automotive applications, (ii) noise and vibration damping properties that are unaffected by long-term exposure to elevated temperatures, (iii) the ability to cure the material in-situ in high-temperature applications, thus eliminating the need for a separate curing step, (iv) inherent adhesive properties that enable direct application to substrates without the need for priming, intermediate adhesive layers and/or mechanical fasteners and (v) inherent adhesive properties and a durable structure that are relatively unaffected by long-term exposure to elevated temperatures and hot motor oil. Although numerous vibration damping materials are known in the art, most have failed to provide, or have provided only on a limited scale, all of the foregoing properties.

U.S. Pat. No. 6,265,475 discloses vibration damping materials that are generally described as having tanδ peak temperatures ideal for room temperature applications. The materials disclosed comprise a polymer having in its molecular chain a chemical structural unit derived from an acrylic monomer, a methacrylic monomer, an ethylene-acrylic copolymer, an ethylene-methacrylic copolymer or vinyl acetate and at least one damping property imparting agent. The damping imparting agents disclosed include a hindered phenol compound, a phosphite ester compound, a phosphate ester compound, a basic compound containing nitrogen and a hindered amine compound. In addition, the use of a triazine crosslinking agent, a metal soap crosslinking agent, an amine crosslinking agent, a carbamate crosslinking agent, an imidazol crosslinking agent and a sulfur crosslinking agent is disclosed.

U.S. Pat. No. 6,153,709 discloses a chip resistant, noise and vibration damping material comprising a blocked polyurethane prepolymer, an epoxy resin, a filler and a plasticizer. Methods for curing the material by applying the same directly to heat generating substrates are also disclosed.

U.S. Pat. No. 5,635,562 discloses a heat curable, expandable vibration damping material having inherent adhesive properties that comprises an elastomeric polymer, plasticizer, thermoplastic polymer, foaming agent, adhesion promoters and filler. The elastomeric polymers disclosed as being useful include styrene-butadiene copolymers, styrene-butadiene block copolymers, polyisobutylene, ethylene-propylene copolymers and ethylene-propylene diene terpolymers. The thermoplastic polymers disclosed as being useful include ethylene-vinyl acetate, acrylics, polyethylene and polypropylene. The use of peroxide crosslinking agents as Theological modifiers is also disclosed.

U.S. Pat. Nos. 5,624,763 and 5,464,659 disclose a radiation curable vibration damper comprising (a) from about 5 parts to about 95 parts by weight of acrylic monomer and (b) correspondingly, from about 95 parts to about 5 parts by weight of a silicone adhesive. The vibration damper is described as having pressure sensitive adhesive properties, which at times makes an intermediate adhesive layer unnecessary to bond the damper to its substrate. However, the occasional need for high-modulus adhesives to bond the damper to its substrate is also disclosed.

U.S. Pat. No. 5,279,896 discloses a vibration-damping pressure-sensitive adhesive composition containing a crosslinked structure of a copolymer comprising from 75% to 92% by weight of a main monomer comprising an alkyl (meth)acrylate containing from 8 to 12 carbon atoms in its alkyl moiety and from 8% to 25% by weight of a carboxyl-containing monomer whose homopolymer has a glass transition temperature of at least 122° F. (50° C.).

U.S. Pat. No. 5,262,232 discloses an acrylate-only and epoxy-acrylate thermoset resin, which exhibits high temperature vibration damping properties.

U.S. Pat. No. 4,681,816 discloses a vibration damping composition comprising ethylene-(meth)acrylic acid salt copolymers having a specific melting point and a particular heat of fusion. The ethylene-(meth)acrylic acid salt copolymers disclosed include copolymers of ethylene and sodium, potassium or zinc (meth)acrylate. The vibration damping composition is described as being useful in high temperature applications.

U.S. Pat. No. 4,447,493 discloses a visco-elastic material comprising the reaction product of (a) 25% to 75% by weight of an acryloyl or methacryloyl derivative of at least one oligomer, where the oligomer has a glass transition temperature of less than 77° F. (25° C.) and a molecular weight per oligomer of 600 to 20,000, and (b) 75% to 25% by weight of a copolymerizable monomer whose homopolymer has a glass transition temperature of at least 122° F. (50° C.). The use of free-radical initiators to thermally polymerize the visco-elastic material is also disclosed. Specifically, the use of azo compounds, hydroperoxides and peroxides to initiate free-radical polymerizations is disclosed.

### SUMMARY OF THE INVENTION

The present invention provides visco-elastic materials that impart sustained noise and vibration damping properties over a wide range of temperatures, which include the elevated temperatures commonly found in automotive applications. In addition, the visco-elastic materials can be cured in-situ by heat generating substrates, and possess inherent adhesive properties and a durable structure that are unaffected by long-term exposure to elevated temperatures and hot motor oil.

In one embodiment, the visco-elastic materials comprise an ethylene/methyl acrylate elastomer and one or more modifying agents, which provide durable noise and vibration damping properties and inherent adhesive qualities. The visco-elastic materials also comprise one or more thermally-activated crosslinking agents, which allows the materials to be cured in-situ by heat generating substrates. In a second embodiment, the visco-elastic materials comprise a polyacrylic elastomer, one or more modifying agents and one or more thermally-activated crosslinking agents. In a third embodiment, the visco-elastic materials comprise a mixture of ethylene/methyl acrylate and polyacrylic elastomers, one or more modifying agents and one or more thermally-activated crosslinking agents. The second and third embodiments also exhibit the favorable properties described above.

The visco-elastic materials can be used alone in an unconstrained manner to dampen vibrating substrates. Alternatively, the visco-elastic materials can be used to form constrained-layer noise and vibration dampers. Depending on the type of constraining layer used, if any, the materials conform to irregularly-shaped surfaces, while maintaining excellent damping properties over a very wide range of temperatures. Thus, the materials are ideal for automotive applications—both interior and exterior. For example, the materials can be used in connection with automotive powertrain components, such as on the engine front cover, oil pan, valve cover and other applications where typical asphaltic and butyl based dampers lack durability. Because of the high damping performance over a wide range of temperatures, constrained-layer dampers comprising the visco-elastic materials are well-suited for equipment and surfaces operating at cold or hot temperatures, or which may cycle from cold to hot temperatures through continuous periodic use.

### DETAILED DESCRIPTION OF CERTAIN PREFERRED EMBODIMENTS

All percentages, parts and ratios within the Detailed Description, Examples and Claims are by weight unless specifically stated otherwise. In addition, the visco-elastic materials described below and the percentages by weight of their constituents described herein are based on a total constituency of 100%.

The visco-elastic materials comprise an ethylene/methyl acrylate and/or polyacrylic elastomer, one or more modifying agents and one or more thermally-activated crosslinking agents, and can be used to form a constrained-layer noise and vibration damper. The visco-elastic materials provide excellent noise and vibration damping properties over a very wide range of temperatures, and in particular at high-temperatures (>200° F./93° C.). The significant noise and vibration damping properties achieved by the visco-elastic materials are in sharp contrast to those obtained with butyl based visco-elastic materials at temperatures above 200° F. (93° C.).

More specifically, the visco-elastic materials comprise from about 0.1% to about 90.0% of ethylene/methyl acrylate elastomer, from about 0.1% to about 50.0% of at least one modifying agent and from about 0.01% to about 10.0% of at least one thermally-activated crosslinking agent. More preferably, the visco-elastic materials comprise from about 10.0% to about 63.0% of ethylene/methyl acrylate elastomer, from about 0.1% to about 50.0% of at least one modifying agent and from about 0.01% to about 10.0% of at least one thermally-activated crosslinking agent. Still more preferably, the visco-elastic materials comprise from about 10.0% to about 20.0% of ethylene/methyl acrylate elastomer, from about 0.1% to about 50.0% of at least one modifying agent and from about 0.01% to about 10.0% of at least one thermally-activated crosslinking agent.

Alternatively, the visco-elastic materials comprise from about 0.1% to about 90.0% of polyacrylic elastomer, from about 0. 1% to about 50.0% of at least one modifying agent and from about 0.01% to about 10.0% of at least one thermally-activated crosslinking agent. More preferably, the visco-elastic materials comprise from about 10.0% to about 90.0% of polyacrylic elastomer, from about 0. 1% to about 50.0% of at least one modifying agent and from about 0.01% to about 10.0% of at least one thermally-activated crosslinking agent.

The visco-elastic materials may also comprise from about 0.1% to about 90.0% of ethylene/methyl acrylate elastomer, from about 0.1% to about 90.0% of polyacrylic elastomer, from about 0.1% to about 50.0% of at least one modifying agent and from about 0.01% to about 10.0% of at least one thermally-activated crosslinking agent.

Among the commercially available sources of ethylene/methyl acrylate elastomer is VAMAC G, which is available from E.I. du Pont de Nemours and Company. The ASTM D-1418 nomenclature for this elastomer is “AEM,” the IUPAC trivial name is “poly(ethylene-acrylic acid)” and the IUPAC structure based name is “poly[ethylene-co-(1-methoxy carbonyl ethylene)].” Among the commercially available sources of polyacrylic elastomer is HYTEMP Polyacrylate Elastomer, which is available from Zeon Chemicals, Inc. The ASTM D-1418 nomenclature for this elastomer is “ACM,” the IUPAC trivial name is “poly(alkyl acrylate)” and the IUPAC structure based name is “poly[(1-alkoxy carbonyl) ethylene].”

In addition to the ethylene/methyl acrylate and/or polyacrylic elastomers, the one or more modifying agents that comprise the visco-elastic materials provide improved noise and vibration damping properties at elevated temperatures. The modifying agents that can be used in the visco-elastic materials include, but are not limited to, a styrene/butadiene resin, a copolymer of (meth)acrylic esters and styrene, a coumarone-indene resin, a hydrocarbon resin, a phenolic resin and an epoxy resin. These modifying agents can be used either individually or in combination with one another to comprise from about 0.1% to about 50.0% of the visco-elastic materials.

A styrene/butadiene resin is particularly useful for structural reinforcement and for imparting damping properties in the temperature range of 50-150° F. (10-66° C.). The styrene/butadiene resin may have a styrene to butadiene ratio of between 5 to 99 parts styrene based on 100 parts total.

A copolymer of (meth)acrylic esters and styrene is also useful for structural reinforcement and for imparting damping properties in the temperature range of 100-250° F. (38-121° C.). The copolymer of (meth)acrylic esters and styrene may either be of a self-crosslinking or non-self-crosslinking variety. In addition to providing heat resistance properties, the self-crosslinking variety can be used to impart water resistance properties to the visco-elastic materials. Varieties of the (meth)acrylic and styrene copolymer having different glass transition temperatures [T_{g}] may also be used to adjust the temperatures at which optimum damping properties are achieved.

The use of hydrocarbon, phenolic and/or coumarone-indene resins provide structural reinforcement and impart damping properties in the temperature range of 200-350° F. (93-177° C.). In addition, an epoxy resin can be used in the visco-elastic materials as a modifying agent in combination with at least one latent cure agent. This combination is capable of providing effective damping properties in the temperature range of 50-350° F. (10-177° C.). The epoxy resins that are useful in forming the visco-elastic materials include, but are not limited to, a bisphenol A, epoxy phenol novolac, urethane modified bisphenol A and a combination of the foregoing. The latent cure agent may either be a modified or unmodified polyamide, a modified or unmodified polyamine, a modified or unmodified polyimide or a dicyandiamide, or a combination of the foregoing.

The use of one or more thermally-activated crosslinking agents enables the visco-elastic materials to be cured in a separate polymerization step or, more preferably, in-situ by a heat generating substrate. The visco-elastic materials comprise from about 0.01% to about 10.0% of one or more thermally-activated crosslinking agents. There are numerous crosslinking agents that can used in the visco-elastic materials individually or in combination with others to comprise from about 0.01% to about 10.0% of the visco-elastic materials.

In certain preferred embodiments, the visco-elastic materials comprise a peroxide crosslinking agent. In addition to providing the ability to cure the visco-elastic materials in-situ, peroxide crosslinking agents have been shown to impart adhesive qualities by improving the cohesive strength of the visco-elastic materials. The inventors have found that numerous peroxide crosslinking agents can be used either individually or in combination with one another to achieve these favorable properties. Such peroxide crosslinking agents include, but are not limited to, di-2,4-dichlorobenzoyl peroxide, dibenzoyl peroxide, 1,1-di(tertbutylperoxy)-3,3,5-trimethylcyclohexane, 1,1-di(tertbutylperoxy)cyclohexane, n-butyl 4,4-di-(tertbutylperoxy)valerate, t-butyl perbenzoate, dicumyl peroxide, t-butyl cumyl peroxide, di(t-butylperoxy)diisopropylbenzene, 2,5-dimethyl-2,5-di(tert-butylperoxy)hexane, di-t-butyl peroxide, 2,5-dimethyl-2,5-di(tert-butylperoxy)hexyne-3 and cumene hydroperoxide. It should be appreciated by those skilled in the art that peroxides and hydroperoxides which are not disclosed herein, but are capable of being thermally-activated, can be used in the visco-elastic materials. The visco-elastic materials preferably comprise from about 0.01% to about 10.0% of one or more peroxide crosslinking agents. More preferably, the visco-elastic materials comprise from about 1.0% to about 5.0% of one or more peroxide crosslinking agents. Still more preferably, the visco-elastic materials comprise from about 1.0% to about 3.0% of one or more peroxide crosslinking agents.

Other thermally-activated crosslinking agents found to be useful include, but are not limited to, sodium stearate, quaternary ammonium compounds, N,N′-diorthotolylguanidine (DOTG), N,N′-diphenylguanidine (DPG), hexamethylene diamine carbamate (DIAK-1), methylene dianiline (MDA), m-phenylene bis maleimide (HVA-2), triethylenetetramine (TETA) and zinc diacrylate. The foregoing agents can be used individually or in combination with one another to comprise from about 0.01% to about 10.0% of the visco-elastic materials. More preferred amounts of the foregoing agents include from about 0.5% to about 4.0% of sodium stearate, from about 0.2% to about 2.0% of quaternary ammonium compounds, from about 1.0% to about 2.0% of DOTG, from about 1.0% to about 2.0% of DPG, from about 0.2% to about 0.5% of DIAK-1 and from about 3.0% to about 5.0% of zinc diacrylate. Zinc diacrylate can also be used to confer additional adhesive properties to the visco-elastic materials.

The visco-elastic materials containing polyacrylic elastomers may optionally include stearic acid to facilitate crosslinking. Specifically, the visco-elastic materials may comprise from about 0.0% to about 5.0% of stearic acid. More preferably, the visco-elastic materials may comprise from about 0.1% to about 1.0% of stearic acid.

Although the visco-elastic materials are capable of being thermally cured, the inventors have found that significant damping properties can be achieved even before curing. The visco-elastic materials, therefore, can be used to dampen vibrating substrates in a cured or uncured state. Including at least one thermally-activated crosslinking agent in the visco-elastic material, however, provides users the option to cure the material at will if its deemed necessary or desirable.

The visco-elastic materials optionally include one or more plasticizers, diluents and/or processing agents. Examples of plasticizers, diluents and/or processing agents found to be useful in the visco-elastic materials include, but are not limited to, polymeric polyesters, polybutenes, epoxidized soybean oils, monomeric sebacates, polymeric sebacates, monomeric adipates, polymeric adipates, monomeric phthalates, polymeric phthalates, epoxides, monomeric glutarates and polymeric glutarates. These agents can be used alone or in various combinations to comprise from about 0.0% to about 30.0% of the visco-elastic materials.

For example, the visco-elastic materials may comprise from about 0.0% to about 30.0% of polymeric polyesters, polybutenes or epoxidized soybean oils. In certain preferred embodiments, however, the visco-elastic materials may comprise from about 1.0% to about 16.0% of polymeric polyesters, from about 20.0% to about 25.0% of polybutene and/or from about 6.0% to about 16.0% of epoxidized soybean oils. Still more preferably, the visco-elastic materials may comprise from about 3.0% to about 10.0% of polymeric polyesters and/or from about 3.0% to about 10.0% of epoxidized soybean oils. In addition to being useful as a plasticizer, diluent and/or processing agent, polymeric polyesters and epoxidized soybean oils have been shown to confer adhesive properties to the visco-elastic materials. Furthermore, epoxidized soybean oils can be used to impart acid acceptance properties to the visco-elastic materials, which discourages metal corrosion.

The visco-elastic materials may optionally include one or more fillers to provide additional noise and vibration damping properties, polymer reinforcement and to effectively control the cost of producing the desired visco-elastic material. Examples of useful fillers include, but are not limited to, carbon black, calcium carbonate, mica, talc, clay, attapulgite clay, silica and low-density silicate fillers. These fillers may be used either individually or in various combinations to comprise from about 0.0% to about 80.0% of the visco-elastic materials. The visco-elastic materials preferably comprise from about 0.3% to about 60.0% of carbon black, from about 10.0% to about 75.0% of calcium carbonate, mica, talc and/or silica, from about 0.2% to about 25.0% of low-density silicate fillers and/or from about 0.1% to about 1.0% of attapulgite clay. More preferably, the visco-elastic materials may comprise from about 0.3% to about 0.5% of carbon black and/or from about 40.0% to about 65.0% of calcium carbonate.

The visco-elastic materials further provide that one or more antioxidants may optionally be employed to discourage unwanted oxidation and to preserve the structural integrity of the material. There are numerous antioxidants that are known to be useful in discouraging unwanted oxidation. In certain preferred embodiments, the visco-elastic materials employ octylated diphenylamine for this purpose. Other types of antioxidants that are useful in formulating the visco-elastic materials include, but are not limited to, phenolics, quinolines, benzimidazoles, cresols and amines. The visco-elastic materials may optionally comprise from about 0.0% to about 5.0% of antioxidant. More preferably, the visco-elastic materials may comprise from about 0.1% to about 2.0% of antioxidant, and still more preferably may comprise from about 0.2% to about 0.4% of antioxidant.

It should be appreciated by those skilled in the art that the foregoing components, which comprise the visco-elastic materials, may be combined in various ways to achieve different goals. For example, the range of temperatures at which optimal noise and vibration damping is achieved can be adjusted by selecting appropriate modifying agents. As stated, the use of styrene/butadiene resin as a modifying agent may be appropriate for applications in the temperature range of 50-150° F. (10-66° C.), whereas the use of coumarone-indene or hydrocarbon resins may be more appropriate for applications in the temperature range of 200-350° F. (93-177° C.). In addition, the cost of producing the visco-elastic materials will be impacted by individual component availability and cost. Accordingly, the cost of producing the visco-elastic materials can be controlled by selectively choosing the specific amounts and types of components used to formulate the materials with the foregoing considerations in mind.

The visco-elastic materials can be produced in various ways known to those skilled in the art. The following represents a non-limiting example of a method for producing the visco-elastic materials. First, in accordance with the desired volume of visco-elastic material to be produced, appropriate amounts of the individual components that comprise the desired visco-elastic material are obtained in ratios consistent with the foregoing description. Next, the heat (or steam) on an appropriate mixer is preheated to 250-260° F. (121-127° C.). Mixers that can be used to produce the visco-elastic materials include, but are not limited to, a Baker-Perkins (sigma blade) mixer, a Banbury-type mixer, a two roll mill mixer, a planetary-type mixer, a twin screw extruder-type mixer, a mixer/extruder, a dough mixer, a continuous-type mixer and any type of sigma blade or kneader-type mixer known in the art. In addition to cost and availability, the type of mixer used will depend on the volume of visco-elastic material being produced.

The elastomer components are then added to the mixer along with the modifying agents. If the visco-elastic material is to include carbon black, it should be added at this time as well. The foregoing is then mixed for approximately 30-40 minutes. The temperature of the ingredients should be maintained at 250-260° F. (121-127° C.). Next, the plasticizers, diluents, processing agents, antioxidants and/or remaining fillers can be added to the batch. The foregoing is then mixed for approximately 5-10 minutes. After mixing, the heat (or steam) should be deactivated and the batch should be allowed to cool to about 120-200° F. (49-93° C.). While cooling, the batch should be mixed intermittently. When the batch temperature reaches 120-200° F. (49-93° C.), the thermally-activated crosslinking agents can be added. The preferred temperature below which the thermally-activated crosslinking agents should be added will vary. In particular, each crosslinking agent will have a different activation temperature. Of course, agents with relatively lower activation temperatures should be added closer to the 120-160° F. (49-71° C.) range, whereas agents with relatively higher activation temperatures can be added closer to the 160-200° F. (71-93° C.) range.

The batch is then mixed for approximately 5-10 minutes, while keeping the batch temperature below 200° F. (93° C.). After the material is fully mixed, it is removed from the mixer and transferred to an extruder. The visco-elastic material can then be extruded in elongated sheets to the desired thickness. Alternatively, the material can be pressed to the desired thickness. The visco-elastic material can optionally be applied to an appropriate constraining layer to form a constrained-layer noise and vibration damper. The visco-elastic material of a constrained-layer noise and vibration damper should range from 0.5 to 50 mm (0.02 to 2.0 inches) in thickness, with the constraining layer having a thickness of between 0.025 to 5.00 mm (0.001 to 0.200 inches). As stated, the visco-elastic materials have inherent adhesive properties making an intermediate adhesive layer, primer component or mechanical fastener unnecessary to bind the visco-elastic material to the constraining layer. The visco-elastic material can be attached to a constraining layer with a high bond strength by simply heat staking, or baking, the material to the constraining layer. Alternatively, the visco-elastic materials can be used as a single unconstrained layer with a thickness of 0.5 to 50 mm (0.02 to 2.0 inches) to dampen noise and vibration generating substrates.

For most applications, constrained-layer dampers consisting of one constraining layer and one visco-elastic layer is sufficient. In some instances, however, it may be desirable to construct a damper consisting of multiple constraining layers and visco-elastic layers. For example, a noise and vibration damper may also be formed using a visco-elastic/constraining/visco-elastic/constraining layer orientation. In all orientations used, however, it is important that at least one visco-elastic layer is exposed for application to the vibration generating substrate.

The visco-elastic materials can be applied to substrates using methods well-known in the art. Many of the constrained-layer dampers known in the art require that the visco-elastic portion be applied contiguously against the surface of a substrate using an intermediate adhesive layer or mechanical fastener to firmly attach the damper to its substrate. Dampers comprising the visco-elastic materials of the present invention, however, can be applied contiguously against the surface of a substrate without an intermediate adhesive layer or mechanical fastener. More specifically, the visco-elastic materials can be firmly attached to a substrate by simply heat staking, or baking, the damper to its substrate. Alternatively, the heat generated in high temperature applications may be sufficient to firmly attach the damper to its substrate. In general, the visco-elastic materials will bind tightly to various substrates after being exposed to temperatures of about 250° F. (121° C.) or more for at least 15 minutes, which can be achieved through a separate heat staking process or in-situ by heat generating substrates.

When using constrained-layer noise and vibration dampers in some automobile applications, it may be advantageous to permanently attach the constraining layer of the noise and vibration damper to the inner surface of the automobile. This can be achieved using any method known in the art, such as welding the constraining layer to the inner surface of an automotive body panel or using other mechanical means known in the art.

As stated, the visco-elastic materials can be cured in-situ by heat generating substrates. More specifically, the visco-elastic materials can be cured by (i) producing a visco-elastic material consistent with the foregoing description, (ii) directly applying the unconstrained visco-elastic material to a heat generating substrate and (iii) allowing the heat generated by the substrate to cure or polymerize the visco-elastic material. Alternatively, the visco-elastic materials can be cured by (i) producing a visco-elastic material consistent with the foregoing description, (ii) attaching the visco-elastic material to a constraining layer to form a constrained-layer noise and vibration damper, (iii) directly applying the visco-elastic portion of the constrained-layer noise and vibration damper to a heat generating substrate and (iv) allowing the heat generated by the substrate to cure or polymerize the visco-elastic material. Using either method obviates the need for a separate curing or polymerization step before applying the visco-elastic material to a heat generating substrate.

The following non-limiting examples demonstrate the excellent vibration damping properties imparted by the visco-elastic materials over a very wide range of temperatures. In addition, the following will demonstrate that the visco-elastic materials have excellent self-adhesive properties, and are relatively unaffected by long-term exposure to elevated temperatures and hot motor oil.

### EXAMPLES

### Example 1

Damping Properties

Various formulations of the visco-elastic materials were tested for vibration damping properties over a wide range of temperatures and vibrational frequencies. More specifically, a visco-elastic material consisting of about 18.7% ethylene/methyl acrylate elastomer, 3.7% styrene/butadiene resin, 3.7% copolymer of (meth)acrylic esters and styrene, 3.7% coumarone-indene resin, 0.4% carbon black, 56.3% calcium carbonate, 5.0% polymeric polyester plasticizer, 6.2% epoxidized soybean oil, 0.4% octylated diphenylamine (antioxidant) and 1.9% di(t-butylperoxy)diisopropylbenzene (peroxide crosslinking agent) was tested (Material-A). In addition, a visco-elastic material consisting of about 15.2% ethylene/methyl acrylate elastomer, 4.5% styrene/butadiene resin, 13.5% copolymer of (meth)acrylic esters and styrene, 0.4% carbon black, 53.7% calcium carbonate, 4.8% polymeric polyester plasticizer, 6.0% epoxidized soybean oil, 0.4% octylated diphenylamine (antioxidant) and 1.5% di(t-butylperoxy)diisopropylbenzene (peroxide crosslinking agent) was tested (Material-B). A visco-elastic material consisting of about 12.5% ethylene/methyl acrylate elastomer, 6.2% polyacrylic elastomer, 3.7% styrene/butadiene resin, 3.7% copolymer of (meth)acrylic esters and styrene, 3.7% coumarone-indene resin, 0.4% carbon black, 56.3% calcium carbonate, 5.0% polymeric polyester plasticizer, 6.2% epoxidized soybean oil, 0.4% octylated diphenylamine (antioxidant) and 1.9% di(t-butylperoxy)diisopropylbenzene (peroxide crosslinking agent) was also tested (Material-C). The composition of the foregoing materials is summarized in Table-1.

TABLE 1

| Component | Material-A | Material-B | Material-C |
|---|---|---|---|
| Ethylene/methyl acrylate | 18.7% | 15.2% | 12.5% |
| copolymer | | | |
| Polyacrylic polymer | — | — | 6.2% |
| Styrene/butadiene resin | 3.7% | 4.5% | 3.7% |
| Copolymer of (meth)acrylic | 3.7% | 13.5% | 3.7% |
| esters & styrene | | | |
| Coumarone-indene resin | 3.7% | — | 3.7% |
| Carbon black | 0.4% | 0.4% | 0.4% |
| Calcium carbonate | 56.3% | 53.7% | 56.3% |
| Polymeric polyester | 5.0% | 4.8% | 5.0% |
| plasticizer | | | |
| Epoxidized soybean oil | 6.2% | 6.0% | 6.2% |
| Antioxidant | 0.4% | 0.4% | 0.4% |
| Peroxide crosslinking agent | 1.9% | 1.5% | 1.9% |

The visco-elastic materials tested were about 3.0 mm to 3.3 mm (0.12 to 0.13 inches) thick and were bound to a 0.25 mm (0.01 inch) constraining layer made of foil. In addition, the visco-elastic materials were thermally-cured at 250° F. (121° C.) for 30 minutes prior to testing. The materials were tested using an Oberst procedure as described in SAE J1637. Oberst testing involves applying a sample material to a substrate, such as a steel bar, and disposing the combined substrate and material in an Oberst Testing Apparatus. The substrate used in the Examples described herein was a 0.8 mm (0.032 inch) thick steel bar. Using this method, the vibration damping properties of a visco-elastic material was measured by its composite loss factor.

A composite loss factor measures the conversion of external vibrational energy into heat energy by internal friction in the visco-elastic material. The higher the composite loss factor, the greater the amount of vibrational energy that is converted to heat. The conversion of vibrational energy into heat also reduces the noise that would otherwise be produced by the vibrating substrate. Thus, in addition to being a metric for vibration damping, the composite loss factor serves as an indicator for noise damping.

It should be appreciated by those skilled in the art that the preferred range of composite loss factors will vary depending on the relative thickness of the substrate used during testing. For the Examples described herein, which employ a 0.8 mm (0.032 inch) thick steel substrate, a visco-elastic material having a composite loss factor of about 0.05 or greater is preferred, and still more preferably has a composite loss factor of about 0.1 or greater. The damping properties of Material-A and Material-B were also compared to those exhibited by a previously known visco-elastic material, which also comprises the ethylene/methyl acrylate elastomer found in VAMAC G (available from E.I. du Pont de Nemours and Company), under similar conditions (the “Comparative Material”). Table-2 sets forth the composite loss factors observed over the range of temperatures and vibrational frequencies tested using Materials-A, -B and -C. Table-3 sets forth the composite loss factors observed using Material-A, Material-B and the Comparative Material.

TABLE-2

| | Material-A | | | Material-B | | | Material-C | | |
|---|---|---|---|---|---|---|---|---|---|
| Temperature | 200 | 400 | 800 | 200 | 400 | 800 | 200 | 400 | 800 |
| (° C.) | Hz | Hz | Hz | Hz | Hz | Hz | Hz | Hz | Hz |
| 10 | 0.3424 | 0.3160 | 0.2916 | 0.0929 | 0.1857 | 0.2475 | 0.3662 | 0.3456 | 0.3261 |
| 25 | 0.3375 | 0.3841 | 0.2964 | 0.1986 | 0.2053 | 0.2122 | 0.3822 | 0.3789 | 0.3756 |
| 40 | 0.2317 | 0.2010 | 0.1783 | 0.2800 | 0.2837 | 0.2875 | 0.2897 | 0.2358 | 0.1580 |
| 55 | 0.1951 | 0.1365 | 0.0995 | 0.3607 | 0.3582 | 0.2480 | 0.1825 | 0.1311 | 0.1012 |
| 70 | 0.1699 | 0.1087 | 0.0784 | 0.3162 | 0.2585 | 0.1763 | 0.1362 | 0.0932 | 0.0633 |
| 85 | 0.1416 | 0.0878 | 0.0663 | 0.2158 | 0.1512 | 0.1029 | 0.0978 | 0.0649 | 0.0464 |
| 100 | 0.1054 | 0.0659 | 0.0528 | 0.1500 | 0.0990 | 0.0677 | 0.0715 | 0.0480 | 0.0368 |
| 115 | 0.0816 | 0.0514 | 0.0423 | 0.1099 | 0.0719 | 0.0505 | 0.0553 | 0.0385 | 0.0321 |

As shown in Table-2, Materials-A,-B and -C exhibit excellent damping properties over a very wide range of temperatures and vibrational frequencies. In addition to meeting the preferred minimum composite loss factor of 0.05 under most test conditions, the materials exhibited a composite loss factor of 0.1 or greater in many instances.

Furthermore, as shown in Table-3, Material-A and Material-B exhibited superior damping properties over the Comparative Material. More particularly, the visco-elastic materials demonstrated superior damping properties over the Comparative Material at all vibrational frequencies tested for temperatures at or above 40° C.

TABLE-3

| | Material-A | | | Material-B | | | Comparative Material | | |
|---|---|---|---|---|---|---|---|---|---|
| Temperature | 200 | 400 | 800 | 200 | 400 | 800 | 200 | 400 | 800 |
| (° C.) | Hz | Hz | Hz | Hz | Hz | Hz | Hz | Hz | Hz |
| 10 | 0.3424 | 0.3160 | 0.2916 | 0.0929 | 0.1857 | 0.2475 | 0.4648 | — | — |
| 25 | 0.3375 | 0.3841 | 0.2964 | 0.1986 | 0.2053 | 0.2122 | 0.4248 | 0.3839 | 0.3268 |
| 40 | 0.2317 | 0.2010 | 0.1783 | 0.2800 | 0.2837 | 0.2875 | 0.1102 | 0.0827 | 0.0722 |
| 55 | 0.1951 | 0.1365 | 0.0995 | 0.3607 | 0.3582 | 0.2480 | 0.0633 | 0.0403 | 0.0308 |
| 70 | 0.1699 | 0.1087 | 0.0784 | 0.3162 | 0.2585 | 0.1763 | 0.0471 | 0.0296 | 0.0211 |
| 85 | 0.1416 | 0.0878 | 0.0663 | 0.2158 | 0.1512 | 0.1029 | 0.0401 | 0.0242 | 0.0180 |
| 100 | 0.1054 | 0.0659 | 0.0528 | 0.1500 | 0.0990 | 0.0677 | 0.0350 | 0.0215 | 0.0172 |
| 115 | 0.0816 | 0.0514 | 0.0423 | 0.1099 | 0.0719 | 0.0505 | 0.0288 | 0.0186 | 0.0169 |

### Example 2

Adhesive Properties

The visco-elastic materials were also tested for inherent adhesive properties. The following describes an adhesion test conducted using a material consisting of about 18.8% ethylene/methyl acrylate elastomer, 3.8% styrene/butadiene resin, 3.8% copolymer of (meth)acrylic esters and styrene, 3.8% coumarone-indene resin, 0.03% carbon black, 56.4% calcium carbonate, 5.0% polymeric polyester plasticizer, 6.3% epoxidized soybean oil, 0.4% octylated diphenylamine (antioxidant) and 1.9% di(t-butylperoxy)diisopropylbenzene (peroxide crosslinking agent), which is substantially similar to Material-A described above. The 90° peel strength of the visco-elastic material was determined after a two hour dwell without any applied heat and after heating the material for 15 minutes, 24 hours, 100 hours, 250 hours, 500 hours, 750 hours and 1000 hours at 250° F. (121° C.). In addition, the material was tested using various types of substrates, which included aluminum, cast aluminum and cold rolled steel. A visco-elastic material having a minimum 90° peel strength of 10.0 lbs/inch (1750 N/m) is generally preferred, but the GM149M Requirement is only 5.0 lbs/inch (875 N/m).

TABLE 4
90° Peel Strength (lbs/inch) [N/m]

| | | Cast | Cold Rolled | GM149M |
|---|---|---|---|---|
| Exposure | Aluminum | Aluminum | Steel | Requirement |
| 2-hour dwell | (22.9) | (7.0) | (15.3) | (5.0) |
| (No Bake) | [4010] | [1226] | [2679] | [875] |
| 15 minutes at | (51.7) | (59.8) | (58.4) | (5.0) |
| 250° F. | [9054] | [10,472] | [10,227] | [875] |
| (121° C.) | | | | |
| 24 hours at 250° F. | (53.6) | (28.0) | (60.9) | (5.0) |
| (121° C.) | [9386] | [4903] | [10,665] | [875] |
| 100 hours at 250° F. | (54.8) | (29.8) | (49.1) | (5.0) |
| (121° C.) | [9596] | [5219] | [8598] | [875] |
| 250 hours at 250° F. | (51.6) | (42.4) | (58.3) | (5.0) |
| (121° C.) | [9036] | [7425] | [10,209] | [875] |
| 500 hours at 250° F. | (41.0) | (55.7) | (44.4) | (5.0) |
| (121° C.) | [7180] | [9754] | [7775] | [875] |
| 750 hours at 250° F. | (44.8) | (37.2) | (56.4) | (5.0) |
| (121° C.) | [7845] | [6514] | [9877] | [875] |
| 1000 hours at | (46.6) | (37.0) | (47.3) | (5.0) |
| 250° F. | [8160] | [6479] | [8283] | [875] |
| (121° C.) | | | | |

As shown in Table-4, the visco-elastic material demonstrates excellent adhesion to all substrates tested after exposure to high temperatures. In addition, Table-4 shows that prolonged exposure to high temperatures does not significantly affect its adhesive qualities.

### Example 3

Resistance to Motor Oil Exposure

The effect that exposure to motor oil and heat have on the adhesive properties and structural integrity of the visco-elastic materials was also determined. First, Material-A was baked for 72 hours at 250° F. (121° C.) to a cast aluminum substrate. The test material and substrate were then immersed in 30W motor oil at 250° F. (121° C.). The visco-elastic material was tested for its 90° peel strength and weight gain after 250, 500 and 1000 hours of exposure to the hot motor oil. As shown in Table-5, the visco-elastic material retained excellent adhesion properties to cast aluminum under these conditions. In addition, the visco-elastic material exhibited a weight gain of less than 1% after 500 hours of continuous exposure to heat and motor oil.

TABLE 5

| | 90° Peel Strength | |
|---|---|---|
| Hours Immersed | (lbs/inch) [N/m] | Percent Weight Gain |
| 250 | (38.0) | 0.70% |
| | [6654] | |
| 500 | (40.4) | 0.82% |
| | [7075] | |
| 1000 | (32.0) | 1.08% |
| | [5604] | |

As shown in Table-5, the structural integrity and adhesive properties of the visco-elastic material were generally unaffected by continuous exposure to heat and motor oil.

### Example 4

Resistance to Age

The effect that time has on the adhesive properties of the visco-elastic materials was determined by measuring the 90° peel strength of Material-A over the course of ninety (90) days using aluminum substrates. All samples were stored at room temperature, and were baked for fifteen (15) minutes at 250° F. (121° C.) prior to testing. The 90° peel strength of the visco-elastic material after 90-days of storage at room temperature was >25 lbs/inch (>4378 N/m). Thus, the shelf life of the visco-elastic material is at least 90 days.

Various modifications and alterations of this invention will become apparent to those skilled in the art without departing from the scope and principles of this invention, and it should be understood that this invention is not to be unduly limited to the illustrative embodiments set forth hereinabove. All patents are incorporated herein by reference to the same extent as if each individual patent was specifically and individually indicated to be incorporated by reference.

What is claimed is:

1. A noise and vibration damping material, which comprises:
(A) from about 0.1% to about 90.0% of ethylene/methyl acrylate elastomer;
(B) from about 0.1% to about 50.0% of at least one modifying agent, wherein said modifying agent is selected from the group consisting of a styrene/butadiene resin, a copolymer of (meth)acrylic esters and styrene, a coumarone-indene resin, a hydrocarbon resin, a phenolic resin and at least one epoxy resin used in combination with at least one latent cure agent; and
(C) from about 0.01% to about 10.0% of at least one thermally-activated crosslinking agent, wherein said thermally-activated crosslinking agent allows said damping material to be cured in-situ by heat generating substrates.

2. The noise and vibration damping material according to claim 1, wherein the amount of said ethylene/methyl acrylate elastomer is from about 10.0% to about 63.0%.

3. The noise and vibration damping material according to claim 1, wherein the amount of said ethylene/methyl acrylate elastomer is from about 10.0% to about 20.0%.

4. The noise and vibration damping material according to claim 1, wherein said thermally-activated crosslinking agent is a peroxide crosslinking agent.

5. The noise and vibration damping material according to claim 4, wherein said peroxide crosslinking agent is selected from the group consisting of di-2,4-dichlorobenzoyl peroxide, dibenzoyl peroxide, 1,1-di(tertbutylperoxy)-3,3,5-trimethylcyclohexane, 1,1-di(tertbutylperoxy)cyclohexane, n-butyl 4,4-di-(tertbutylperoxy)valerate, t-butyl perbenzoate, dicumyl peroxide, t-butyl cumyl peroxide, di(t-butylperoxy)diisopropylbenzene, 2,5-dimethyl-2,5-di(tert-butylperoxy)hexane, di-t-butyl peroxide, 2,5-dimethyl-2,5-di(tert-butylperoxy)hexyne-3 and cumene hydroperoxide.

6. The noise and vibration damping material according to claim 4, wherein the amount of said peroxide crosslinking agent is from about 1.0% to about 5.0%.

7. The noise and vibration damping material according to claim 4, wherein the amount of said peroxide crosslinking agent is from about 1.0% to about 3.0%.

8. The noise and vibration damping material according to claim 1, wherein said thermally-activated crosslinking agent is selected from the group consisting of sodium stearate, quaternary ammonium compounds, N,N′-diorthotolylguanidine, N,N′-diphenylguanidine, hexamethylene diamine carbamate, methylene dianiline, m-phenylene bis maleimide, triethylenetetramine and zinc diacrylate.

9. The noise and vibration damping material according to claim 1, wherein said modifying agent comprises an epoxy resin selected from the group consisting of a bisphenol A, an epoxy phenol novolac and a urethane modified bisphenol A.

10. The noise and vibration damping material according to claim 9 further comprising a latent cure agent selected from the group consisting of a modified polyamide, an unmodified polyamide, a modified polyamine, an unmodified polyamine, a modified polyimide, an unmodified polyimide and a dicyandiamide.

11. The noise and vibration damping material according to claim 1 further comprising a plasticizer, wherein said plasticizer is selected from the group consisting of polymeric polyesters, polybutenes, epoxidized soybean oils, monomeric sebacates, polymeric sebacates, monomeric adipates, polymeric adipates, monomeric phthalates, polymeric phthalates, epoxides, monomeric glutarates and polymeric glutarates.

12. The noise and vibration damping material according to claim 1 further comprising a filler, wherein said filler is selected from the group consisting of carbon black, calcium carbonate, mica, talc, clay, attapulgite clay, silica and low-density silicate fillers.

13. The noise and vibration damping material according to claim 1, wherein (i) the amount of said ethylene/methyl acrylate elastomer is from about 10.0% to about 20.0%, (ii) said modifying agent comprises from about 3.0% to about 4.0% of styrene/butadiene resin, from about 3.0% to about 4.0% of a copolymer of (meth)acrylic esters and styrene, and from about 3.0% to about 4.0% of a coumarone-indene resin and (iii) said thermally-activated crosslinking agent comprises from about 1.0% to about 3.0% of at least one peroxide crosslinking agent.

14. The noise and vibration damping material according to claim 1, wherein (i) the amount of said ethylene/methyl acrylate elastomer is from about 10.0% to about 20.0%, (ii) said modifying agent comprises from about 4.0% to about 5.0% of styrene/butadiene resin and from about 13.0% to about 14.0% of a copolymer of (meth)acrylic esters and styrene and (iii) said thermally-activated crosslinking agent comprises from about 1.0% to about 3.0% of at least one peroxide crosslinking agent.

15. A noise and vibration damping material, which comprises:
(A) from about 0.1% to about 90.0% of polyacrylic elastomer;
(B) from about 0.1% to about 50.0% of at least one modifying agent, wherein said modifying agent is selected from the group consisting of a styrene/butadiene resin, a copolymer of (meth)acrylic esters and styrene, a coumarone-indene resin, a hydrocarbon resin, a phenolic resin and at least one epoxy resin used in combination with at least one latent cure agent; and
(C) from about 0.01% to about 10.0% of at least one thermally-activated crosslinking agent, wherein said thermally-activated crosslinking agent allows said damping material to be cured in-situ by heat generating substrates.

16. The noise and vibration damping material according to claim 15, wherein the amount of said polyacrylic elastomer is from about 10.0% to about 90.0%.

17. The noise and vibration damping material according to claim 15, wherein said thermally-activated crosslinking agent is a peroxide crosslinking agent.

18. The noise and vibration damping material according to claim 17, wherein said peroxide crosslinking agent is selected from the group consisting of di-2,4-dichlorobenzoyl peroxide, dibenzoyl peroxide, 1,1-di(tertbutylperoxy)-3,3,5-trimethylcyclohexane, 1,1-di(tertbutylperoxy)cyclohexane, n-butyl 4,4-di-(tertbutylperoxy)valerate, t-butyl perbenzoate, dicumyl peroxide, t-butyl cumyl peroxide, di(t-butylperoxy)diisopropylbenzene, 2,5-dimethyl-2,5-di(tert-butylperoxy)hexane, di-t-butyl peroxide, 2,5-dimethyl-2,5-di(tertbutylperoxy)hexyne-3 and cumene hydroperoxide.

19. The noise and vibration damping material according to claim 17, wherein the amount of said peroxide crosslinking agent is from about 1.0% to about 5.0%.

20. The noise and vibration damping material according to claim 17, wherein the amount of said peroxide crosslinking agent is from about 1.0% to about 3.0%.

21. The noise and vibration damping material according to claim 15, wherein said thermally-activated crosslinking agent is selected from the group consisting of sodium stearate, quaternary ammonium compounds, N,N′-diorthotolylguanidine, N,N′-diphenylguanidine, hexamethylene diamine carbamate, methylene dianiline, m-phenylene bis maleimide, triethylenetetramine and zinc diacrylate.

22. The noise and vibration damping material according to claim 15, wherein said modifying agent comprises an epoxy resin selected from the group consisting of a bisphenol A, an epoxy phenol novolac and a urethane modified bisphenol A.

23. The noise and vibration damping material according to claim 22 further comprising a latent cure agent selected from the group consisting of a modified polyamide, an unmodified polyamide, a modified polyamine, an unmodified polyamine, a modified polyimide, an unmodified polyimide and a dicyandiamide.

24. The noise and vibration damping material according to claim 15 further comprising a plasticizer, wherein said plasticizer is selected from the group consisting of polymeric polyesters, polybutenes, epoxidized soybean oils, monomeric sebacates, polymeric sebacates, monomeric adipates, polymeric adipates, monomeric phthalates, polymeric phthalates, epoxides, monomeric glutarates and polymeric glutarates.

25. The noise and vibration damping material according to claim 15 further comprising a filler, wherein said filler is selected from the group consisting of carbon black, calcium carbonate, mica, talc, clay, attapulgite clay, silica and low-density silicate fillers.

26. A noise and vibration damping material, which comprises:
(A) from about 0.1% to about 90.0% of ethylene/methyl acrylate elastomer;
(B) from about 0.1% to about 90.0% of polyacrylic elastomer;
(C) from about 0.1% to about 50.0% of at least one modifying agent, wherein said modifying agent is selected from the group consisting of a styrene/butadiene resin, a copolymer of (meth)acrylic esters and styrene, a coumarone-indene resin, a hydrocarbon resin, a phenolic resin and at least one epoxy resin used in combination with at least one latent cure agent; and
(D) from about 0.01% to about 10.0% of at least one thermally-activated crosslinking agent, wherein said thermally-activated crosslinking agent allows said damping material to be cured in-situ by heat generating substrates.

27. A method for curing the noise and vibration damping material of claim 1, which comprises (i) producing said damping material, (ii) directly applying said damping material to a heat generating substrate and (iii) allowing the heat generated by said substrate to cure said damping material.

28. A method for curing the noise and vibration damping material of claim 15, which comprises (i) producing said damping material, (ii) directly applying said damping material to a heat generating substrate and (iii) allowing the heat generated by said substrate to cure said damping material.

29. A method for curing the noise and vibration damping material of claim 26, which comprises (i) producing said damping material, (ii) directly applying said damping material to a heat generating substrate and (iii) allowing the heat generated by said substrate to cure said damping material.
